(19) United States
(12) Patent Application Publication
(10) Pub. No.: US 2002/0035494 A1
(43) Pub. Date: Mar. 21, 2002

(54) Systems and methods for facilitating real estate advertising distribution

(76) Inventors: Victoria K. Eckes, Boulder, CO (US); Steven P. Eckes, Boulder, CO (US); Kim E. Sayers, Littleton, CO (US); Brian L. Ercek, Golden, CO (US)

Correspondence Address: Attn: Curtis A. Vock, Lathrop & Gage, L.C., Suite 302, 4845 Pearl East Circle, Boulder, CO, 80301, US

(21) Appl. No.: 09/765,715

(22) Filed: Jan. 19, 2001

Related U.S. Application Data
(60) Provisional application No. 60/176,862, filed on Jan. 19, 2000.

(51) Int. Cl. G06F 17/60; G06F 15/16

(52) U.S. Cl. 705/7; 705/14; 709/219

(57) ABSTRACT

The invention is a multilevel modular database software product distribution system to enable multiple small and medium sized business entities to operate interactively with one another using the World Wide Web as an application service provider to an extended participatory subscriber network for advertising production and distribution. It provides a system whereby information collected in a proprietary database and distributed for presentation at a level where real estate shoppers can make decisions based on accurate information about a local community—information that can only be assembled by local people who really know the communities. In this system, such people would be Real estate professionals and a local newspaper or other community-based organization that sells advertising and/or other services to real estate professionals.

### RELATED APPLICATIONS

This application claims priority to U.S. Provisional Application No. 60/176,862, filed on Jan. 19, 2000 and entitled “Systems and Methods for Facilitating Real Estate Office Productivity,” which is hereby expressly incorporated herein by reference.

### BACKGROUND

Real Estate information distribution is a fast-growing area of the Internet, and several vendors similar to one another have emerged in recent years to serve the real estate industry, particularly to impart information about real estate agents, agencies, and properties listings. The usual method to do this is to establish a large national Web site with various real estate information sections. Typically, these Web sites use prepared third-party databases from national vendors who produce information about communities, such as schools, crime, and state real estate law that are based on national government statistics. The weakness in this approach is that the data are homogenized into large, generalized reports that are not accurate enough for people to use in making decisions about real estate purchases. Such large real estate portal Web sites may be useful for locating properties in a very generalized way, but more information is needed for real estate buyers to locate the specific types of properties they want, located in the types of neighborhoods or communities within a metropolitan area in which they are interested.

For example, a large city school district may contain an area with disappointing student achievement, but may also have neighborhoods with high achieving schools. The current databases supplied to the large portals by the national vendors use statistics averaging to arrive at figures that may be very misleadingly low for the neighborhood with high achieving schools. The same problem may be seen when crime statistics or income levels for these disparate neighborhoods are reported.

Large real estate portals allow searches for listings by price, beds and baths, and city/community. The information given about the communities is insufficient for real estate shoppers to identify the characteristics of an area in which they might want to live, as the searches provided are only by community name. Persons not already thoroughly familiar with these named communities cannot find an area of interest without assistance by someone very familiar with the community. The real estate portals do not give them efficient methods to find such persons. Real estate shoppers face a real problem when they want to get specialized, accurate information about a neighborhood or community within a city. Likewise, real estate professionals and advertising outlets face problems in trying to deliver such information to the shoppers.

### SUMMARY OF THE INVENTION

The invention is a multilevel modular database software product distribution system to enable multiple small and medium sized business entities to operate interactively with one another using the World Wide Web as an application service provider to an extended participatory subscriber network for advertising production and distribution. It provides a system whereby information collected in a proprietary database and distributed for presentation at a level where real estate shoppers can make decisions based on accurate information about a local community-information that can only be assembled by local people who really know the communities. In this system, such people would be Real estate professionals and a local newspaper or other community-based organization that sells advertising and/or other services to real estate professionals.

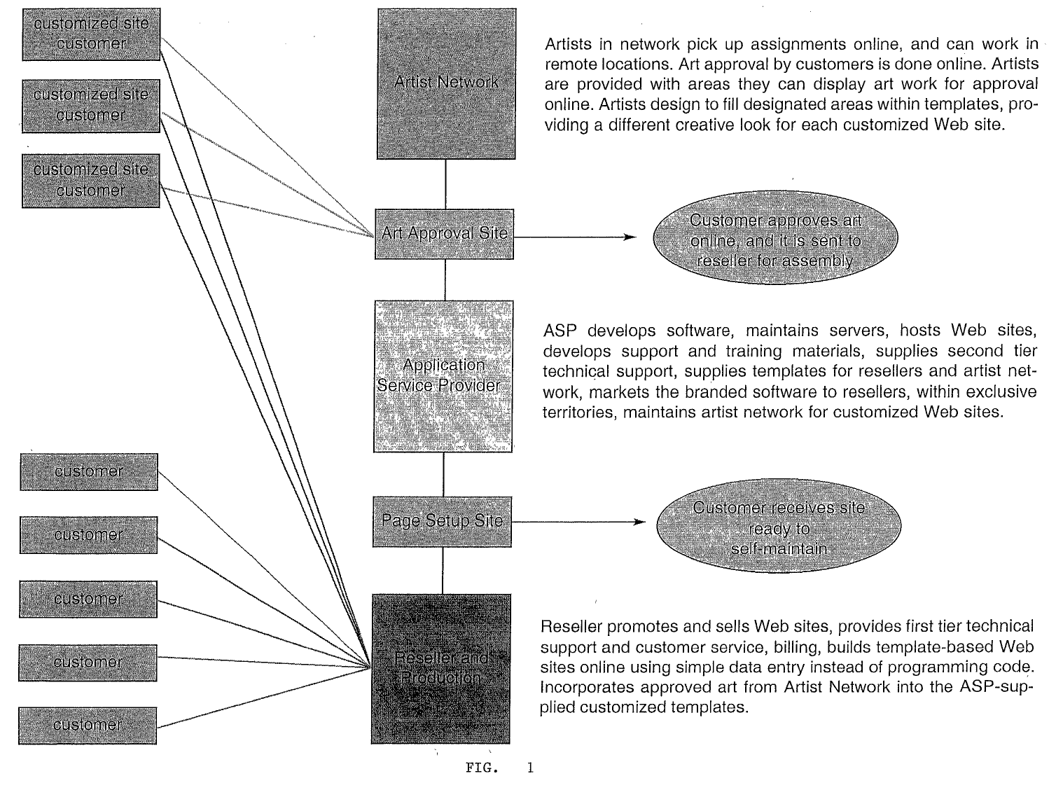

FIG. 1 Business System Schema of the Invention.

The system includes search capabilities for listings and agents within several different and distinct proprietary databases, which include:

Communities

Specialty property types

Price, beds and baths

Agencies and agents

Online home tours

The databases are interrelated, accessed through secure servers with password-protected accounts for each of the levels of users: administrative, distributor administration, and broker administration, and agent/listings administration. The purpose for this interrelational database is so that many users can share limited subscription access to the same large database and administration software, presented on one, or many distinct Web sites. The database is distinct from competitor products because it allows interrelated searches on the subscribed public Web sites for listings and agents on multiple levels described above. To do this, a listing or agent is given the opportunity in the secured access back office to assign the property, agency or agent to certain property types created by the database administrators on several of the administration levels. This is different from other relational database technologies in that it bridges the usability gap between highly technical large “database mining” and “data star” technologies to provide a level of user ease and convenience unseen before now. To get this level of searchability in databases in technologies available in the marketplace, a user needed to learn and use highly technical Boolean and non-Boolean command line codes. With this new technology, the only skills a person needs are beginner computer user skills, and how to use a Web Browser. A single listing or agent can be found by a real estate shopper in multiple types of searches. A real estate professional, for example, could showcase a certain property in separate searches on entry search pages for multiple picture online home tours, a highly desired community name, a golf course specialty property type, Price, beds and baths, and by agency or agent. The system gives listings and the real estate professionals selling them multiple points of presence within a single Web site. No other system that has emerged on the market has sought to give people marketing real estate so many ways to accurately give people shopping for real estate such a comprehensive way to conduct a property search. This is accomplished by the multiple-level database mining searches described above.

There are often many specialized types and classifications of properties that people are seeking, such as golf course homes, condos and lofts, lakeshore, etc. None of the large national real estate portals offer this collection of specialized information to people wanting to buy specialized types of properties in specified small geographic areas. This invention offers a comprehensive real estate marketing and management package in one application. It goes even further by giving the print publishing company distributors a seamless method for automating production using digital information downloaded from MLS organizations, as well as information entered directly into the system by a secured access customer.

In addition, the product offers Internet advertising production features designed to integrate with the most popular print production software on the market, such as digital asset management systems and page assembly software like QuarkXPress and Photoshop. Thus, the product offers a way for publishing company distributors to use the same digital assets for print and online advertising production. Public Web site end users are able to save search criteria and automatically receive notification when properties listings that meet their criteria become available on the market. The end user may also select a real estate company or agent to be notified when a property they might want to see becomes available in the database. All of the multiple level search criteria available in the searches is used in compiling this information for the end users.

An integral part of the system is the “Artist Network” feature, which lets customers review and approve artwork that is produced by artists they choose online from a group of people who produce online and print art work to specifications compatible with the system. A customer approval system of art provides a way for customers to view, comment on, and approve the art work for their Web site electronically, online, through an Internet browser.

### The Artist Network Module

For providing art to fill customizable page “containers.” Artist network can be internal or external to the reseller facility, or provided as a service by the ASP host to many resellers. All art is designed to fit predetermined page templates

1. Assignment pickup: Automated through database system. The reseller enters an art order into the system.

2. Template and style standards coordinate with the layout style chosen by the customer with assistance by customer service staff at the reseller facility

3. Database alert system notifies artists in the network that an assignment is available

4. Artist takes the assignment, and the reseller is notified by the database alert system that the project has been assigned

5. Review System: Artists upload their work into the review templates and update the project status through database alert system

6. Database alert system notifies the reseller and the customer about the updated status

Review comments, including whether the art is accepted, rejected, or accepted with changes as noted are forwarded to the artist for revision, and the artist is notified by the database alert system that a project has returned from first review

The system has the capability to receive and format text and pictures in GIF and JPEG formats, upload and download documents in text and Portable Document Format (PDF) formats, integrate with voice messaging products, integrate with Virtual Reality tour products available on the market, integrate with Java and other scripting languages, and create forms and satellite and stand alone Web sites.

The system gives the distributors of the products the ability to generate individual Web sites for other distributors, agencies, and agents, and to connect them into the database system. Using a simple set of instructions, new administrators, users and passwords can be created, by a person with certain specified access privileges. Sophisticated programming knowledge is not necessary, since all pages are created from page assembly templates provided with the system, or artist network art work, using simple forms, or an option to use HTML coding to produce additional capabilities unavailable in the system currently.

The system gathers marketing information and data for customers to use in analyzing the effectiveness of their marketing strategies.

Web hosting facility module: maintained by the Application Service Provider.

All software is developed and maintained by the ASP.

1. Server farm

2. Software distribution and upgrades

3. Distribution partner triage and technical support

The Reseller facility structure module

1. Coordinating distribution: Order-taking is done by telephone and online, by customer service staff, who “build” Web pages by entering customer information in data entry fields that correspond with areas in a Web page template selected for appearance by the customer.

2. Communicates to customers information needed to supply additional setup content for the Web site.

3. Optional content support services such as scanning and art creation

4. End user and customer service support

5. Production facility (Automated, template-based)

6. Production facility (Non-automated)

7. Billing

Reseller can provide automated design service at two levels. All resellers will provide Standard template-based sites. At their option, they can add an internal customized art service using the Artist Network Module, or outsource the Artist Network Module to the ASP.

1. Standard template-based artwork

2. Customizable templates for custom art “containers”

Customized art is designed to fit into predefined page areas, described as pixel areas or “containers.”

Container specifications include a Home page and secondary page design

Standard customer deliverables

Standard Template Web Sites: Based on pre-designed Web site page templates

1. Home Page with header, body copy, navigation bar and footer with contact information and e-mail link

2. Inventory listing page-assembled “on the fly” by the database

3. “About” page to be used for information about the company or its personnel

4. Customer Contact form

5. Resources and links page

6. Generic page to use for content of the client's choice

7. Password protected Back Office site maintenance pages for administrative staff to use in updating the Web site

Add, edit, and delete categories and links

Add, edit and delete individual personnel information pages

Add, edit, and delete inventory, pictures and movies

Contact management

Maintain pictures, text and hyperlinks on all pages

Obtain Web site statistics

Maintain meta names and meta tags

### Customized art container Web sites

Based on customized art ordered through the Artist Network.

1. Home Page with header, body copy, navigation bar and footer with contact information and e-mail link

2. Inventory listing page-assembled “on the fly” by the database

3. “About” page to be used for information about the company or its personnel

4. Customer Contact form

5. Resources and links page

6. Generic page to use for content of the client's choice

7. Password protected Back Office site maintenance pages for administrative staff to use in updating the Web site

Add, edit, and delete categories and links

Add, edit and delete individual personnel information pages

Add, edit, and delete inventory, pictures and movies

Contact management

Maintain pictures, text and hyperlinks on all pages

Obtain Web site statistics

Maintain meta names and meta tags

8. Newsletter Page

9. Up to ten optional pages, with body copy layout to be chosen at option of customer from a variety of pre-designed page elements which include specified numbers of pictures or movies, text blocks, subheads, and hyper links.

APPENDIX A contains, for disclosure purposes, non-limiting source code applicable for use in constructing and/or illustrating the invention.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method for managing real estate information, comprising the steps of:
forming a real estate network with a top tier of one or more servers, at least one mid-level distributor tier, and at least one low-level back office tier;
configuring the one or more servers with the real estate information for distribution to the network;
enabling remote access to the servers at the mid-level distributor tier to manage the real estate information and to manage low-level back office tier access to the real estate information; and
enabling remote access to the servers at the low level back office tier to manage part of the real estate information.

2. A method of claim 1, wherein the mid-level distributor tier comprises a newspaper.

3. A method of claim 1, further comprising generating pages by HTML using database information.

4. A method for managing real estate information, comprising the steps of:
forming a real estate network with a top tier of one or more servers and at least one low-level back office tier;
configuring the one or more servers with the real estate information for distribution to the network; and
enabling remote access to the servers at the low level back office tier to manage the real estate information.
